(19) United States
(12) Patent Application Publication
(10) Pub. No.: US 2004/0136078 A1
(43) Pub. Date: Jul. 15, 2004

(54) Structure and manufacture of a light capture device

(76) Inventors: Ho-Yuan Shueh, Shindian City (TW); Chia-Chang Wu, Fengyuan City (TW)

Correspondence Address: Ho-Yuan SHUEH & Chia-Chang Wu, P.O. Box No.6-57, Chung-Ho, Taipei, 235, TW

(21) Appl. No.: 10/339,303

(22) Filed: Jan. 10, 2003

(51) Int. Cl. G02B 27/10

(52) U.S. Cl. 359/619

(57) ABSTRACT

A light capture device includes a base plate mainly has a proper number of base holes disposed on a top plane thereon; a convex enclosing rib or concave slot is disposed on the peripheral side of the base hole; a diaphanous bead is disposed respectively on the front side of the base hole; a base support layer fills among the diaphanous beads with a certain thickness at the upper aspect of the base plate; opposite the diaphanous beads, a contact plane of the base support layer forms as a base bowl with an arcuate recess to assist the holding of the diaphanous bead such that the light ray emitted from the rear aspect of the base plate penetrates the base hole, projects into the diaphanous beads and toward the outside.

### BACKCGROUND OF THE INVENTION

1) Field of the Invention

The present invention relates to a structure and manufacture of a light capture device, more particularly to a light capture device to be used in a liquid crystal display module; the present invention is especially molded through injection to have a base plate disposed with a proper number of intense base holes; intense diaphanous beads are disposed on one lateral plane thereof to allow a light source to project directly from the base hole area on the rear portion of the base plate to obtain an even light projection effect with high brightness; relatively, the present invention is characterized that it reduces the number of light source tubes, saves electricity and is environmental friendly.

2) Description of the Prior Art

Accordingly, the display device has been improved along with the advance of the industrial technology. Although the conventional cathode ray tube (CRT) was the main trend in the industrial field, it has been replaced by the liquid crystal display (LCD). Especially, the European and American countries have established laws to prohibit the application of CRT due to its harmful radiation. LCD has become popular because the technology of manufacturing the surface plate thereof has been improved and the mass production thereof has gradually lowered the cost; furthermore, LCD is electricity-saving and thinner.

The primary LCD module projects light mainly from two opposite sides of a screen and uses a prism or light guiding plate to deflect the light ray; then the light ray is evenly mixed by a diffusion piece, intensified by a light amplifying plate and projected to the screen; wherein, after being deflected and mixed by the diffusion piece, the strength of the light ray naturally decreases and has to be supplemented by the light amplifying plate. However, the prices of the light amplifying plate and the diffusion piece are quite expensive; that is the shortcoming of the conventional structure. Furthermore, the brightness obtained from the design is not preferred and the viewing angle is smaller. Therefore, the conventional structure is suitable only for personal notebook computer screen but not for television screen with high brightness.

The trend of application has focused more on the development of the screen with high brightness. For example, the conventional light capture device with low brightness is not sufficient for the television screen or a large-sized bulletin board. Therefore, the industry aims to use a direct back light through disposing a plurality of upright and side-by-side light tubes at the back aspect of the screen as a light source; a diffusion piece is disposed at the front aspect of the light tubes for evenly diffusing the light ray outwardly without showing the contours of the light tubes. However, the brightness of the light ray becomes insufficient after being mixed; therefore a light amplifying piece is provided to intensify the brightness. The expensive prices of the light amplifying piece and the diffusion piece relatively increase the cost of the display module. In general, the design of the upright light tubes arranged in lines, the diffusion piece and the light amplifying piece of the conventional structure makes the cost higher; in addition, the multiple-layer structure is not convenient for assembly. These are the most obstacles of applying the light capture device on a television with a wide viewing angle (to be viewed by numerous audience) and a large-sized bulletin board.

In application, the conventional light capture device has the following shortcomings:

1. The cost of purchasing parts, such as the light amplifying plate at the price of several ten dollars, the diffusion piece and a plurality of light tubes, is quite high; that specifically makes it difficult to promote the audio-visual products with high brightness and a screen with wide viewing angle thereby influencing the advance of the technology.

2. Although the light mixture effect of the diffusion piece evenly diffuses the light ray, it also reduces the brightness thereof; so it is necessary to add an expensive light amplifying plate to enhance the brightness. In addition, the number of the light tubes used as the light source in the abovementioned manufacture has to be increased relatively and that consumes more electricity. More especially, the computer screen or bulletin board is popularly used nationally and internationally nowadays. Any wrong design might consume or waste considerable electricity within a couple of or tens of years; that is not in compliance with the concept of the environmental conservation and needs more improvement.

### SUMMARY OF THE INVENTION

Therefore, the primary objective of the present invention is to discard the expensive conventional light amplifying piece, not to adapt the light guiding plate to decrease the brightness of the light, but to particularly develop a light capture device with high brightness and even projection so as to save the manufacturing cost and the electricity.

In order to achieve the abovementioned objective, the present invention comprises a base plate with a plurality of base holes disposed thereon; a diaphanous bead is respectively disposed at the front aspect of each base hole; a base support layer fills among the diaphanous beads with a certain thickness at the upper aspect of the base plate for firmly inserting the diaphanous bead such that the light ray emits from the rear aspect of the base plate, penetrates the base hole, projects into the diaphanous bead and diffuses outwardly so as to obtain light ray with even brightness, eliminate the cost of conventional diffusion piece and light amplifying piece, reduce the number of the light tubes and save electricity.

Another objective of the present invention is to manufacture the abovementioned structure through injection molding for serial operation in mass production so as to lower the manufacture cost.

To enable a further understanding of the technical contents of the present invention, the brief description of the drawings is followed by the detailed description of a preferred embodiment.

### BRIEF DESCRIPTION OF THE DRAWINGS

FIG. 1 is a pictorial and external view drawing of the present invention.

FIG. 2A is the first partially cross-sectional drawing of an exemplary embodiment of the present invention.

FIG. 2B is the second partially cross-sectional drawing of an exemplary embodiment of the present invention.

FIG. 3 is a cross-sectional and structural drawing of the present invention.

FIG. 4 is a bird's-eye view drawing of another bead net of the present invention.

FIG. 5 is a bottom view and structural drawing of FIG. 4.

### DETAILED DESCRIPTION OF THE PREFERRED EMBODIMENTS

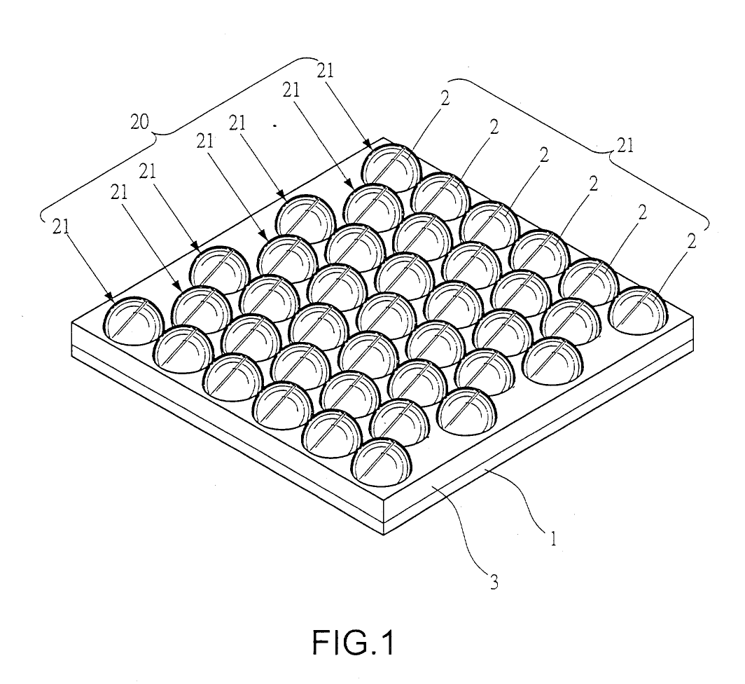

Referring to FIGS. 1, 2A and 3, the present invention mainly comprises a base plate (1), a proper number of diaphanous beads (2) and a base support layer (3) unitarily molded; the base plate (1) and the base support layer (3) are preferred to be made by high molecular and polymer material; the diaphanous bead (2) is preferred to be made by material with high diaphaneity, such as acrylic or glass.

Wherein, the base plate (1) is unitarily molded and has a plurality of intense and crossed base holes (12) with preferred dual diameters; that means, the diameter of the base hole (12) on one lateral side on the base plate (1) is larger than the one on the other lateral side; the larger diameter is in a bowl shape for fitly holding the diaphanous bead (2).

The diaphanous beads (2) are respectively disposed on the front lateral sides of the base holes (12) of the base plate (1); more particularly, they are placed at the area of a larger hole diameter of the base hole (2). The diaphanous beads (2) of the same line connect each other to form a string of bead rod (21). The diaphanous beads (2) or bead rods (21) can be unitarily molded to connect each other to form a bead net (20). The abovementioned structure is suitable for injection molding in mass production and convenient for manufacturing.

The base support layer (3) is filled among the diaphanous beads (2) at the front lateral side of the base plate (1). The thickness of the base support layer (3) approximately covers half of the height of the diaphanous bead (2); an arcuate concave base bowl (31) is formed on the base support layer (3) opposite the contact plane of the diaphanous bead (2) to assist the holding of the diaphanous bead (2).

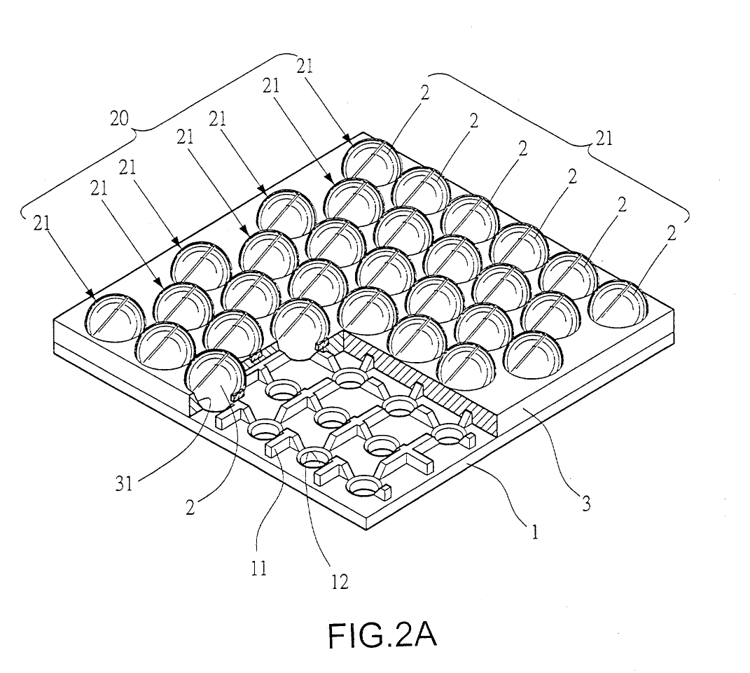

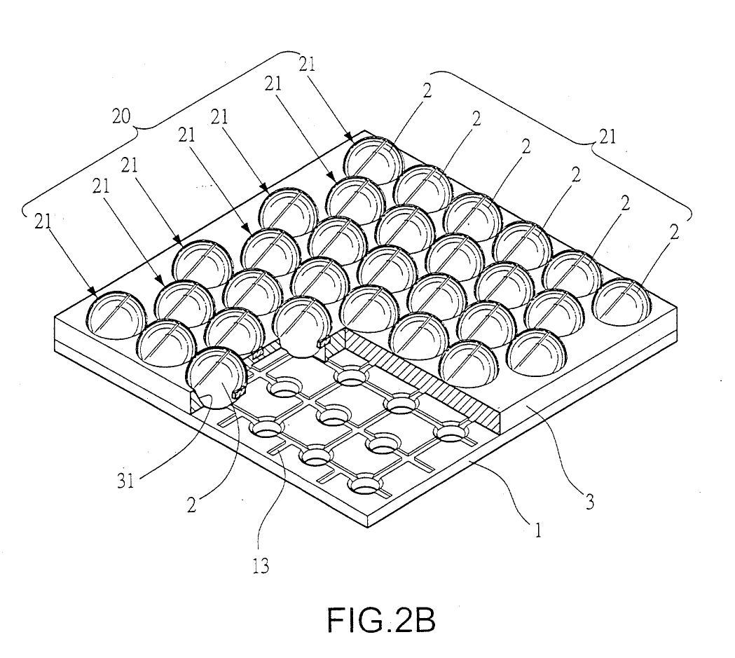

For tighter and firmer binding between the base plate (1) and the base support layer (3), a concave or convex melting and connecting structure is disposed between them. As indicated in FIG. 2A, the outer lateral peripheries of the base holes (12) on the base plate (1) are respectively disposed with a plurality enclosing ribs (11) to firmly connect the base plate (1) and the base support layer (3) to prevent separation. In addition, as indicated in FIG. 2B, a plurality of concave slots (13) are respectively disposed on the outer peripheries of the base holes (12) with larger diameters on the base plate (1) such that during the connection, the base support layer (3) fills and permeates therein to hold fixedly to prevent separation. That is another exemplary embodiment.

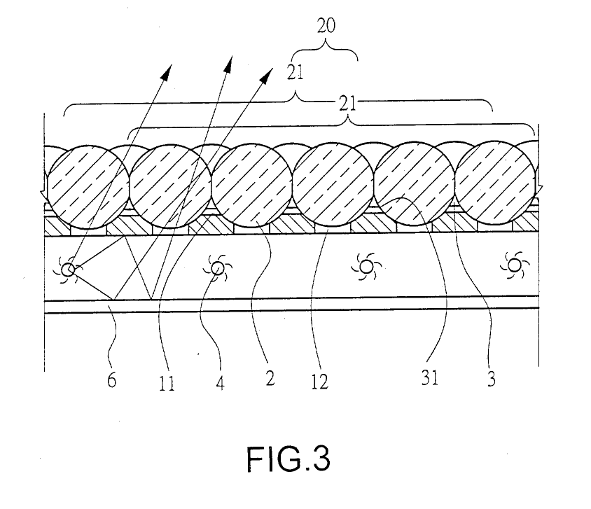

Referring to FIGS. 2A and 3, a light source (4) is disposed on a back light plate (6) behind the base plate (1); the light source (4) emits the light ray from the rear aspect of the base plate (1), penetrates the base hole (12), projects into the diaphanous bead (2) and then condenses the light to project again thereby obtaining sufficient and brilliant light ray; or, the light ray deflects for several times between the back plane of the base plate (1) and the back light plate (6), then projects into the diaphanous bead (2) from the base hole (12) to condense the light and prevent energy waste.

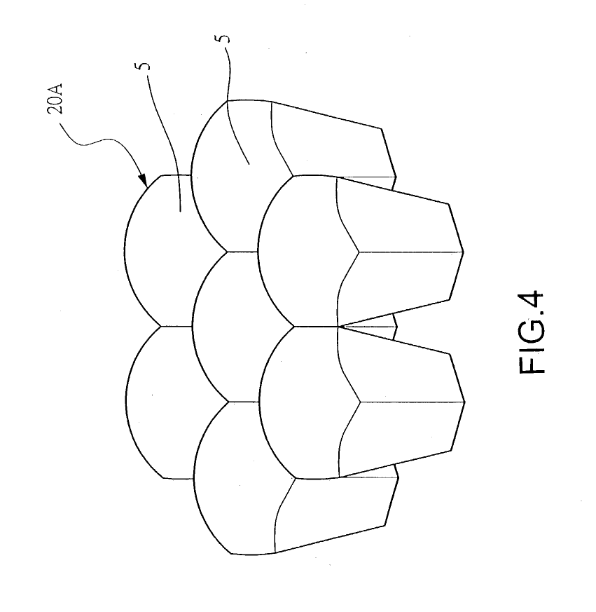

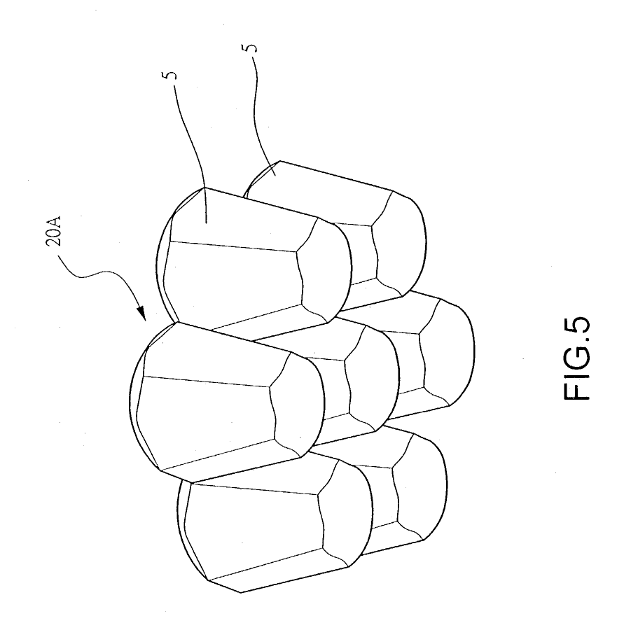

FIGS. 4 and 5 show a structure of another kind of bead net (20A); mainly an ineffective portion (the area not projected by the light ray) on the peripheral side of each diaphanous bead (5) is cut off to connect the diaphanous beads (5) thereby forming an intense bead net (20A) with higher brightness. The lower aspect of the diaphanous bead (50) shrinks slightly to allow the base support layer (3) shown in FIG. 2A to fill therein so as to make the connection more stable.

Furthermore, as indicated in FIG. 5, the projecting-out portion of the top portion of each diaphanous bead (5) and the projecting-in portion at the lower aspect of the light ray is of a spherical side; the shape and height of an annular peripheral side at the center are not limited since the light ray does not pass.

The manufacture of the present invention, as indicated in FIGS. 1 and 2A includes:

A. Steps of injecting the base plate (1):

A base die is disposed for using high molecular and not transparent material to inject the base plate (1); a plurality of base holes (12) are disposed on the plate surface; the peripheries of the base holes (12) are disposed with a plurality of enclosing ribs (11) or concave slots (13).

B. Steps of injecting the diaphanous beads (2):

The diaphanous beads (2) are made of highly transparent material; the diaphanous beads (5) are molded through injection at the front sides of the base holes (12) of the base plate (1) with a pre-molded die; more particularly, the diaphanous beads (2) on the same row form the bead rod (21); or, the diaphanous beads (2) connect to form the bead net (20).

C. Steps of injecting the base support layer (3):

The base support layer (3) is also made of high molecular material and molded through injection among the diaphanous beads (2) with a certain thickness at the front aspect of the base plate (1). During the molding injection, the thermal melting makes the binding between the base support layer (3) and the enclosing rib (11) or the concave slot (13) of the base plate (1) firmer; the thickness of the base support layer (3) approximately covers half of the height of the diaphanous bead (2); an arcuate concave base bowl (31) is formed on the base support layer (3) opposite the contact plane of the diaphanous bead (2) to assist the holding of the diaphanous bead (2).

The present invention is manufactured according to the abovementioned steps.

Furthermore, FIGS. 1 and 2 show the other variation in manufacture. The steps thereof include:

A. Steps of injecting the diaphanous beads (2):

A plurality of diaphanous beads (2) are molded through injection by highly transparent material. The diaphanous beads (2) connect each other to form the bead net (20).

B. Steps of synchronously injecting the base plate (1) and the base support layer (3):

The base plate (1) is molded through injection by the high molecular and not transparent material; a plurality of intense base holes (12) are disposed on the plate surface thereof; the base holes (12) face the bottom portions of the diaphanous beads (2); the base support layer (3) is injected to fill in among the diaphanous beads (2); the thickness of base support layer (3) the filling approximately covers half of the height of the diaphanous bead (2); an arcuate concave base bowl (31) is formed on the base support layer (3) opposite the contact plane of the diaphanous bead (2) to assist the holding of the diaphanous bead (2). A light capture device of the same structure is manufactured accordingly.

Referring to FIG. 3, in implementation, the light source (4) at the rear aspect (the lower aspect of the Figure) of the base plate (1) emits the light ray to pass the base hole (12) area and projects outwardly through the diaphanous beads (2). The rest not projected light ray deflects continuously between the base plate (1) and the back light plate (6) thereby repetitively condensing and using the light ray to intensify the brightness.

Therefore, the embodiment of the present invention achieves the following effectiveness and advantages:

The present invention intensely diffuses the light ray from the back side of the diaphanous bead to form an even and whole light source for obtaining even brightness; more especially, the light source of the present invention achieves the best light condensing effect via the base hole and the diaphanous bead; the adjacent light ray has the overlapping effect; with multiple light ray arranged in rows, the brightness thereof is surely better than that of the arrangement of the conventional light tubes. Therefore, the display has more even brightness to suit the displayer and television with high brightness and larger surface plate.

The light ray of the present invention condenses easily; relatively, the required light source is less. More especially, the device of the present invention consumes lower light ray and does not need a light amplifying piece or a diffusion plate for mixing the light or increasing the brightness thereby saving the cost by eliminating those two parts. Furthermore, the number of the light tubes is relatively reduced so as to achieve the effect of saving electricity and conserving the environment.

The serial injection molding of the present invention allows rapid, mass and consistent production. More particularly, using injection molding, the product quality of the present invention is consistent and the quantity is steadier. Manufacturing through dies allows molding for different dimensions and assemblies thereby facilitating the application.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A structure of a light capture device mainly has a base plate, a proper number of diaphanous beads and a base support layer unitarily molded; wherein:
a plurality of intense base holes are disposed on the surface of the base plate for holding the diaphanous beads;
the base support layer is flatly disposed among the diaphanous beads at the upper aspect of the base plate to connect them into one unit; on the base support layer and opposite the contact plane of the diaphanous bead, an arcuate concave slot is formed to assist the holding of the diaphanous bead.

2. The structure of a light capture device according to claim 1, wherein, a hole diameter of the base hole on one side of the base plate is larger than that on the other side; the lateral side of the base hole with larger hole diameter is in a bowl shape for holding the diaphanous bead.

3. The structure of a light capture device according to claims 1 or 2, wherein a plurality of convex enclosing ribs are respectively disposed on peripheral sides at the front lateral sides of the base holes on the base plate.

4. The structure of a light capture device according to claims 1 or 2, wherein a plurality of concave slots are respectively disposed on the peripheral sides at the front lateral sides of the base holes on the base plate.

5. The structure of a light capture device according to claims 1, wherein the diaphanous beads on the same row connect each other to form a bead rod.

6. The structure of a light capture device according to claims 1, wherein the diaphanous beads connect with each other located at the front, rear, left or right aspects to form a whole bead net.

7. The structure of a light capture device according to claims 1, wherein the base plate and the base support layer are made of high molecular polymer.

8. The structure of a light capture device according to claims 1, wherein the diaphanous bead is made of material with high diaphaneity.

9. The structure of a light capture device according to claims 1, wherein the diaphanous bead is in a spherical shape.

10. The structure of a light capture device according to claims 1, wherein an ineffective portion (the area not projected by the light ray) on the peripheral side of each diaphanous bead is cut off thereby connecting the diaphanous beads to form an more intense bead net.

11. The structure of a light capture device according to claims 1, wherein the contact area between the bottom portion of the diaphanous bead and the base hole of the base plate is of a spherical surface; the projecting-out side of the light ray at the upper aspect is also of a spherical surface; the shape and height of an annular peripheral side at the center are not limited.

12. A manufacture of a light capture device includes at least the following steps:
A. steps of injecting the base plate (1):
a base die is disposed for using high molecular and not transparent material to inject the base plate; a plurality of base holes are disposed on the plate surface; the peripheries of the base holes are disposed with a plurality of enclosing ribs or concave slots;
B. steps of injecting the diaphanous beads:
the diaphanous beads are made of highly transparent material; the diaphanous beads are molded through injection at the front sides of the base holes of the base plate;
C. steps of injecting the base support layer:
the base support layer is made of high molecular material and molded through injection among the diaphanous beads with a certain thickness at the front aspect of the base plate; during the molding injection, the thermal melting makes the binding between the base support layer and the enclosing rib or the concave slot of the base plate firmer; the thickness of the base support layer approximately covers half of the height of the diaphanous bead; an arcuate concave base bowl is formed on the base support layer opposite the contact plane of the diaphanous bead to assist holding the diaphanous bead.

13. The manufacture of a light capture device according to claim 12, wherein, the base plate and the base support layer are made of high molecular polymer.

14. The manufacture of a light capture device according to claim 12, wherein the diaphanous bead is made of material with high diaphaneity.

15. The manufacture of a light capture device according to claim 12, wherein the diaphanous beads on the same row connect each other to form a bead rod.

16. The manufacture of a light capture device according to claim 12, wherein the diaphanous beads connect with each other located at the front, rear, left or right aspects to form a whole bead net.

17. A manufacture of a light capture device comprises at least:
A. steps of injecting the diaphanous beads:
a plurality of diaphanous beads are molded through injection by the highly transparent material; the diaphanous beads connect each other to form a bead net;
B. steps of synchronously injecting the base plate and the base support layer:
the base plate is molded through injection by the high molecular and not transparent material; a plurality of intense base holes are disposed on the plate surface thereof; the base holes face the bottom portions of the diaphanous beads; the base support layer is injected to fill in among the diaphanous beads; the thickness of the filling approximately covers half of the height of the diaphanous bead; an arcuate concave base bowl is formed on the base support layer opposite the contact plane of the diaphanous bead to assist holding the diaphanous bead; a light capture device of the same structure is manufactured accordingly.
